(19) United States
(12) Patent Application Publication
(10) Pub. No.: US 2024/0303862 A1
(43) Pub. Date: Sep. 12, 2024

(54) CAMERA CALIBRATION USING A VEHICLE COMPONENT LOCATION IN FIELD OF VIEW

(71) Applicant: Ford Global Technologies, LLC, Dearborn, MI (US)

(72) Inventors: David Michael Herman, West Bloomfield, MI (US); Yashanshu Jain, Dearborn, MI (US)

(73) Assignee: Ford Global Technologies, LLC, Dearborn, MI (US)

(21) Appl. No.: 18/181,351

(22) Filed: Mar. 9, 2023

(51) Int. Cl. G06T 7/80; B62D 15/02; G06V 20/59; H04N 17/00

(52) U.S. Cl. CPC G06T 7/80; B62D 15/024; G06V 20/59; H04N 17/002; G06T 2207/10048; G06T 2207/20021; G06T 2207/30244; G06T 2207/30268; H04N 23/56

(57) ABSTRACT

A vehicle configured to update a driver-facing camera calibration model is disclosed. The vehicle may include a steering wheel assembly including a steering wheel and a steering wheel angle sensor. The vehicle may further include a driver-facing camera mounted in proximity to the steering wheel. The vehicle may additionally include a processor configured to obtain a steering wheel rotation angle from the steering wheel angle sensor, and an interior vehicle image from the driver-facing camera. The processor may be further configured to identify a steering wheel location in the interior vehicle image. The processor may determine that the driver-facing camera may be misaligned based on the identified steering wheel location and the steering wheel rotation angle. The processor may update the driver-facing camera calibration model when the processor determines that the camera may be misaligned.

### TECHNICAL FIELD

The present disclosure relates to a vehicle camera calibration system and method, and more particularly, to a system and method for calibrating a vehicle driver state monitoring camera (DSMC) using a vehicle component location in a camera field of view (FOV).

### BACKGROUND

Many modern vehicles use driver alertness detection systems to detect driver alertness level. A driver alertness detection system may detect when a driver may be fatigued or when the driver takes eyes off the road. For example, the driver alertness detection system may detect when the driver's vision has deviated from the road for a certain time duration, and may output an audible or visual alarm to remind the driver to focus the eyes back on the road.

A driver alertness detection system generally includes a driver-facing camera that may be mounted in proximity to a vehicle steering wheel. The driver-facing camera may capture a view of driver's eyes or head, and the system may detect whether the driver is focusing on or off the road based on the captured view.

While the driver alertness detection system may provide benefits to the driver, the system may be susceptible to outputting false alarms when the driver-facing camera is misaligned relative to a nominal or center-aligned position. For example, if the camera is misaligned, the system may incorrectly detect that the driver's vision has deviated from the road, even when the driver's eyes are focused on the road. This may result in false alarm, and hence user inconvenience.

Driver-facing camera may get misaligned due to wear-and-tear and/or when the driver frequently changes steering wheel setting. In addition, the driver-facing camera may get misaligned during repair or maintenance of the vehicle/camera at vehicle dealership, etc. A conventional approach to correct driver-facing camera misalignment is end of line (EOL) calibration. While EOL calibration may correct the camera misalignment, the EOL calibration process may be expensive, time-consuming and complex to execute, and may not be useful in correcting camera misalignment due to wear-and-tear.

Thus, there is a need for a system and method for correctly detecting driver alertness level, even when the driver-facing camera is misaligned.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in which techniques and structures for providing the systems and methods disclosed herein may be implemented.

FIG. 2 depicts a system to calibrate a vehicle driver-facing camera, in accordance with the present disclosure.

FIG. 3 depicts example snapshots of views captured by a vehicle driver-facing camera, in accordance with the present disclosure.

FIG. 4 depicts an example snapshot of a driver image obstructed by a vehicle steering wheel, in accordance with the present disclosure.

FIG. 5 depicts an example 3-dimensional vehicle model in accordance with the present disclosure.

FIG. 6 depicts a flow diagram of an example method for vehicle camera calibration, in accordance with the present disclosure.

### DETAILED DESCRIPTION

### Overview

The present disclosure describes a vehicle having a driver alertness detection system configured to detect whether a vehicle driver is focusing on the road or if driver vision is deviated from the road. The system may include a driver state monitoring camera (DSMC) or a driver-facing camera that may be mounted in proximity to a vehicle steering wheel. The DSMC may capture a driver image and the system may determine driver eyes, hand/arm position(s), or head orientation from the captured image. The system may correlate the driver eyes orientation with a vehicle interior 3-Dimensional (3D) model, and determine that the driver is looking at a vehicle on-road windshield portion or at any other vehicle portion. Responsive to determining that the driver may be looking at the other vehicle portion for more than a threshold time duration, the system may output an audio and/or a visual alert, via a vehicle infotainment system or a user device, to remind or prompt the driver to focus on the road.

The system may be additionally configured to determine that the DSMC is misaligned relative to a nominal or center-aligned position. The system may determine DSMC misalignment by using “obstructions” that may be included in the image that the DSMC may capture. In some aspects, an obstruction may be a view of a vehicle component that may be present in the image captured by the DSMC. For example, the obstruction may be a steering wheel view (or view of any other vehicle component), when the driver rotates the steering wheel. In this case, the system may perform image pixel-segmentation and identify an “actual” steering wheel location (or location of any other vehicle component) in the image. The system may further include one or more light sources mounted in proximity to the DSMC that may be configured to illuminate the steering wheel (and other vehicle interior components) in the image that the DSMC may capture. The system may identify precisely the steering wheel location in the image by using bright illumination of the steering wheel in the image. In additional aspects, the system may identify the steering wheel location by determining changes in illumination intensity of image background due to obstructions in the image. The changes in illumination intensity may depend on steering wheel geometry (e.g., shape and dimensions), reflection of light from the steering wheel, etc.

The system may further obtain steering wheel rotation angle from a steering wheel angle sensor, and determine the angle by which the driver may have rotated the steering wheel. The system may additionally obtain steering wheel geometry, DSMC pitch, roll and yaw information, and the vehicle interior 3D model from a vehicle memory. The system may determine an “estimated” steering wheel location in the image captured by the DSMC based on the steering wheel rotation angle, the steering wheel geometry, DSMC pitch, roll and yaw information, and the vehicle interior 3D model. In some aspects, the estimated steering wheel location may be same as a steering wheel location in the image when the DSMC may be expected to not have any alignment or roll error (i.e., when the DSMC is expected not be misaligned).

Responsive to determining the actual steering wheel location and the estimated steering wheel location, the system may determine an angular difference between the actual and the estimated locations. The system may determine the DSMC to be misaligned when the determined angular difference is greater than a predefined threshold (e.g., 0.5, 1 or 2 degrees).

In some aspects, the system may include one or more cameras (DSMCs) that may capture driver and steering wheel images. Further, the system may determine a DSMC to be misaligned when the system determines angular error and/or translation error. Stated another way, the present disclosure is not limited to determining only angular error between the actual and estimated steering wheel (or vehicle component) locations, and may further include determining translation error.

The system may update a DSMC calibration model or the vehicle interior 3D model based on the determined angular difference (or translation error) to ensure that the system correctly determines the driver eyes or head orientation in the images captured by the DSMC.

The present disclosure discloses a system that provides an alert to the driver when the driver may not be looking at the road while driving. The alert may prompt the driver to focus on the road, and hence enhances driver experience while driving. The system may further determine that the DSMC is misaligned, and perform a corrective action when the DSMC is misaligned. The system does not require any external component and/or end of line calibration to correct DSMC misalignment, and is thus not expensive or complex to implement. The system updates the DSMC calibration model when the DSMC is misaligned, and thus reduces probability of false alarms.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

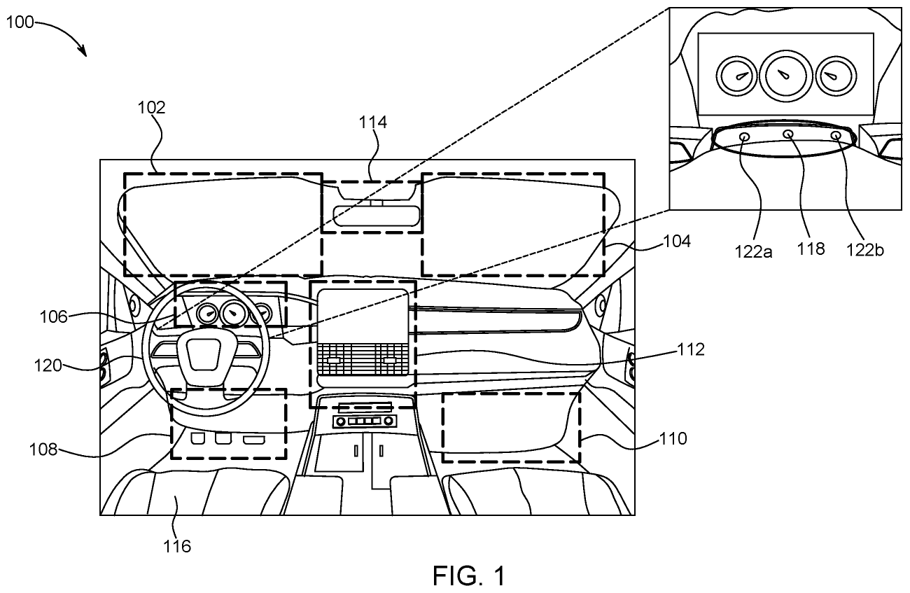

FIG. 1 depicts an example vehicle 100 in which techniques and structures for providing the systems and methods disclosed herein may be implemented. Specifically, FIG. 1 depicts an example snapshot/view of vehicle 100 interior portion. The vehicle 100 may take the form of any passenger or commercial vehicle such as, for example, a car, a work vehicle, a crossover vehicle, a van, a minivan, a taxi, a bus, etc. Further, the vehicle 100 may be a manually driven vehicle, and/or may be configured to operate in a partially autonomous mode, and may include any powertrain such as, for example, a gasoline engine, one or more electrically-actuated motor(s), a hybrid system, etc.

As shown in FIG. 1, the vehicle 100 interior portion may include one or more zones including, but not limited to, an on-road windshield zone 102, an on-road right windshield zone 104, a vehicle cluster zone 106, a vehicle driver lap zone 108, a passenger foot well zone 110, an infotainment system zone 112, a rear-view mirror zone 114, and/or the like. In some aspects, the one or more zones may be areas within the vehicle 100 interior portion that a vehicle driver (not shown) may view or look at, when the driver may be driving the vehicle 100 or sitting at a driver sitting area 116. In some aspects, the one or more zones may be used to determine driver attentiveness or alertness when the driver drives the vehicle 100 (as described below). Specifically, driver gaze origin and direction may be used to determine a zone (or intersection of one or more zones) where the driver may be looking, and hence determine driver alertness level.

The vehicle 100 may include a driver alertness detection system (not shown) that may detect whether the driver is focusing on road or if the driver focus is deviated. For example, the driver alertness detection system (or “system”) may detect whether the driver's eyes are (or head is) oriented towards the on-road windshield zone 102 or oriented towards any other zone, e.g., the infotainment system zone 112 or the on-road right windshield zone 104. The system may output an audio or visual alarm when the system detects that the driver's eyes are oriented towards a zone different from the on-road windshield zone 102 for a time duration greater than a predefined time duration threshold. For example, the system may output an audio notification via vehicle speakers (not shown) when the system detects that the driver's eyes may be oriented towards the infotainment system zone 112 for more than two seconds. As another example, the system may output the audio notification when the system detects that the driver's eyes may be oriented towards the on-road right windshield zone 104 for more than three seconds.

In some aspects, the predefined time duration threshold may be different for different zones. Stated another way, each zone may have a different associated time duration threshold. For example, the on-road right windshield zone 104 may have the associated time duration threshold of 2-3 seconds, the rear-view mirror zone 114 may have the associated time duration threshold of 1-2 seconds, and/or the like. The system may detect a specific zone at which the driver's eyes may be oriented, and may determine/track a time duration for which the driver's eyes may be oriented towards the specific zone. The system may output the audio notification when the determined time duration exceeds the corresponding time duration threshold that is associated with the specific zone. The audio notification may include, for example, a prompt or an alarm for the driver to focus back on the road. Stated another way, the audio notification may prompt the driver to look towards the on-road windshield zone 102.

In some aspects, the system may include a driver-facing camera 118 (or a camera 118) that may be mounted in proximity to a steering wheel 120, as shown in FIG. 1. Specifically, the camera 118 may be mounted between the steering wheel 120 and vehicle cluster. The camera 118 may be a driver state monitoring camera (DSMC) that may be configured to capture driver images when the driver drives the vehicle 100 or sits at the driver sitting area 116.

Although FIG. 1 depicts one camera 118, in some aspects, the system may include one or more driver-facing cameras.

The system may process the driver images captured by the camera 118 (or one or more driver-facing cameras) and determine the zone at which the driver may be looking. In some aspects, the system may use a vehicle interior portion 3-dimensional (3D) model that may be stored in a vehicle memory (not shown) to determine the zone at which the driver may be looking.

Specifically, the system may determine an orientation of driver's eyes (or head) from the captured driver images, and may correlate the determined orientation with the vehicle interior portion 3D model to determine the zone at which the driver may be looking. For example, if the orientation indicates that the driver may be looking at a center-top vehicle interior portion, the system may correlate the determined orientation with the vehicle interior portion 3D model and determine that the driver may be looking at the rear-view mirror zone 114.

In some aspects, the system may be further configured to determine that the camera 118 is aligned at an ideal center-aligned orientation or a nominal position, or if the camera 118 is misaligned. A person ordinarily skilled in the art may appreciate that the system may detect incorrect driver eyes (or head) orientation if the camera 118 is misaligned. For example, if the camera 118 is misaligned, the system may incorrectly detect that the driver may be looking at the rear-view mirror zone 114, even when the driver may be looking at the on-road windshield zone 102. This may result in false alarms. To eliminate false alarm output, the system, as described in the present disclosure, determines whether the camera 118 is misaligned and performs corrective action(s) when the camera 118 is misaligned.

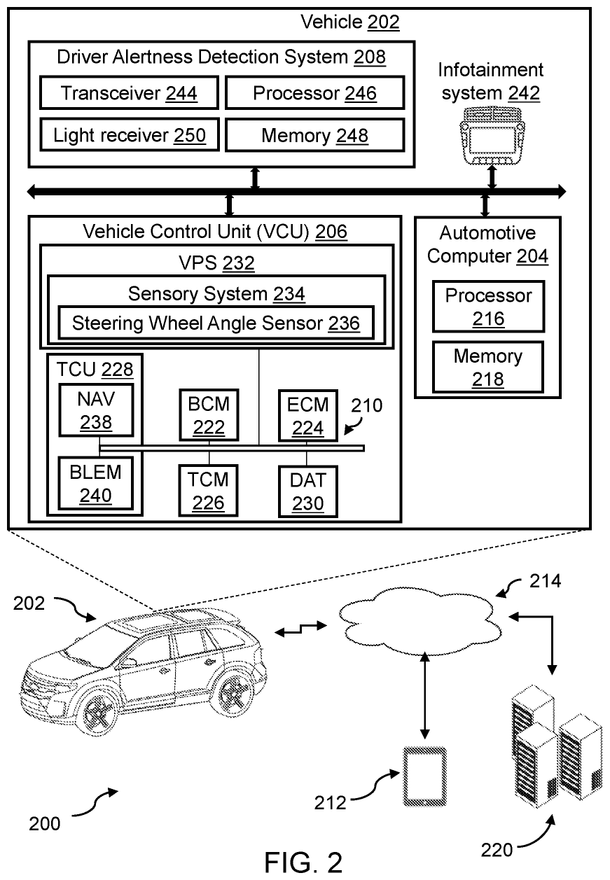

The system may determine that the camera 118 is misaligned by detecting a steering wheel 120 location (or location of any other vehicle component, e.g., a vehicle top window) in a driver image that the camera 118 may capture (or camera's field of view), and by using information associated with camera 118 and steering wheel 120 geometry (that may be pre-stored in the vehicle memory). Specifically, since the camera 118 is mounted in proximity to the steering wheel 120, camera 118 field of view (FOV) may be obstructed when the driver turns the steering wheel 120 left or right. In this case, the driver image captured by the camera 118 may include a portion of steering wheel 120 image. The system may use the “obstruction” in the camera 118 FOV to determine that the camera 118 is misaligned, as briefly described below and described in detail in conjunction with FIG. 2.

In some aspects, the system may perform driver image pixel-segmentation to detect an “actual” steering wheel 120 location in the captured driver image. The system may additionally determine a steering wheel rotation angle from a vehicle steering wheel angle sensor (that may be part of a steering wheel assembly including the steering wheel 120). The system may further determine an “estimated” steering wheel location in the driver image based on the steering wheel rotation angle, camera 118 pitch, roll and yaw information, and the steering wheel 120 geometry (that may be pre-stored in the vehicle memory). The estimated steering wheel location may be same as a steering wheel location in the driver image when the camera 118 may be expected to be aligned at the ideal center-aligned orientation or the nominal position.

Although the description above describes an exemplary manner in which the system may determine the estimated steering wheel location, there may be other manners or parameters that the system may implement/use, based on design considerations of the camera 118, steering wheel 120 geometry, etc., to estimate the steering wheel location. The description above should not be construed as limiting the present disclosure scope by which the system may determine the steering wheel location.

Responsive to determining the estimated steering wheel location and the actual steering wheel location in the driver image, the system may compare and determine an angular difference (or translation error) between the estimated steering wheel location and the actual steering wheel location. The angular difference may be associated with a camera 118 roll error or misalignment angle. The system may determine that the camera 118 may be misaligned if the angular difference is greater than a predefined threshold (e.g., 0.5, 1 or 2 degrees), or if the translation error is greater than a predefined threshold. Responsive to a determination that the camera 118 may be misaligned, the system may use the determined angular difference (or translation error) and update a camera 118 calibration model, so that the system may correctly detect driver eyes (or head) orientation in the driver images that the camera 118 may capture. In some aspects, the system may update the camera 118 calibration model by updating the vehicle interior portion 3D model. The detailed process of determining camera 118 misalignment and updating the camera 118 calibration model may be understood in conjunction with FIG. 2.

In additional aspects, the system may include one or more light sources 122a, 122b that may be disposed on camera 118 left and right sides, respectively. Similar to the camera 118, the light sources 122a, 122b may be mounted in proximity to the steering wheel 120. The light sources 122a, 122b may be, for example, infrared (IR) light sources (specifically, Near-Infrared light sources) that may be configured to emit light beams or signals towards the vehicle 100 interior portion.

In addition to pixel segmentation process, the system may detect or confirm the actual steering wheel 120 location in the driver image based on light signals that may reflect from the steering wheel 120, when the driver rotates the steering wheel 120 and obstructs the light signals emitted from the light source 122a or 122b. In some aspects, the system may cause the light sources 122a, 122b to emit the light signals alternatively, and the system may detect the actual steering wheel 120 location in the driver image based on whether the system receives the reflected light signal emitted from the light source 122a or 122b. In additional aspects, the system may identify the steering wheel location by determining changes in illumination intensity of image background. The changes in illumination intensity may depend on steering wheel geometry (e.g., shape and dimensions), reflection of light from the steering wheel 120, etc.

In further aspects, the light signals emitted from the light sources 122a, 122b illuminate the steering wheel 120 more brightly as compared to other vehicle interior components (since the light sources 122a, 122b are mounted close to the steering wheel 120). Bright illumination of steering wheel 120 may assist the system to differentiate the steering wheel 120 from other vehicle interior components (e.g., vehicle back sitting area, vehicle grip handle, etc.) in the driver image, and hence determine the actual steering wheel 120 location in the driver image precisely using pixel segmentation.

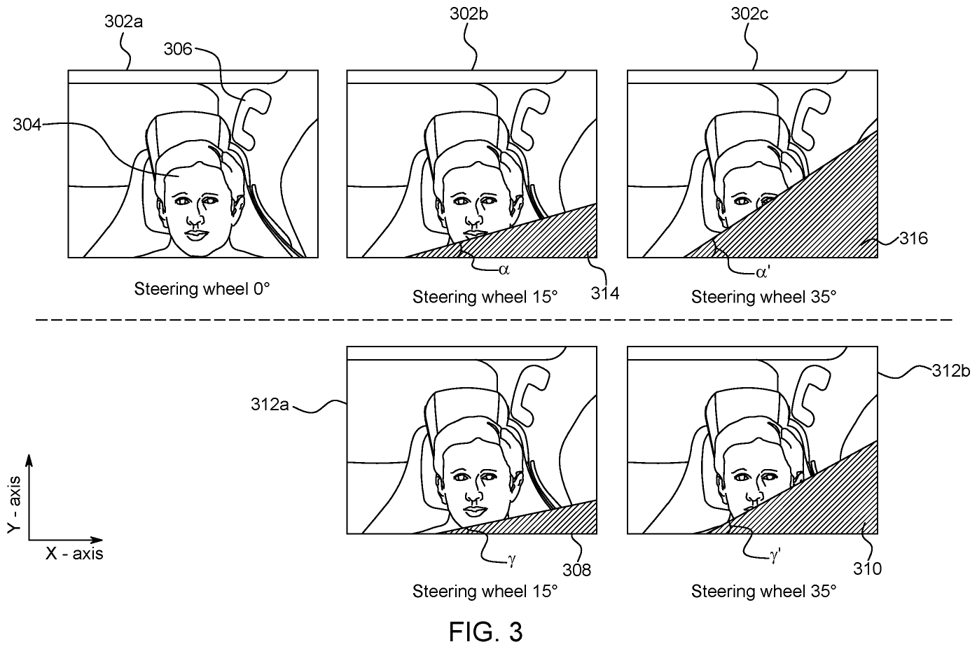

FIG. 2 depicts a system 200 to calibrate a vehicle driver-facing camera, for example the camera 118 (not shown in FIG. 2), in accordance with the present disclosure. While describing FIG. 2, references may be made to FIGS. 3-5.

The system 200 may include a vehicle 202 that may be same as the vehicle 100. The vehicle 202 may include an automotive computer 204, a Vehicle Control Unit (VCU) 206, and a driver alertness detection system 208. The VCU 206 may include a plurality of Electronic Control Units (ECUs) 210 disposed in communication with the automotive computer 204.

The system 200 may further include a mobile device 212 that may connect with the automotive computer 204 and/or the driver alertness detection system 208 by using wired and/or wireless communication protocols and transceivers. In some aspects, the mobile device 212 may be associated with a vehicle user/driver (not shown in FIG. 2). The mobile device 212 may communicatively couple with the vehicle 202 via one or more network(s) 214, which may communicate via one or more wireless connection(s), and/or may connect with the vehicle 202 directly by using near field communication (NFC) protocols, Bluetooth® protocols, Wi-Fi, Ultra-Wide Band (UWB), and other possible data connection and sharing techniques.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or some components of the driver alertness detection system 208 may be installed in a vehicle engine compartment (or elsewhere in the vehicle 202), in accordance with the disclosure. Further, the automotive computer 204 may operate as a functional part of the driver alertness detection system 208. The automotive computer 204 may be or include an electronic vehicle controller, having one or more processor(s) 216 and a memory 218. Moreover, the driver alertness detection system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a camera calibration program code. The memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

In some aspects, the automotive computer 204 and/or the driver alertness detection system 208 may be disposed in communication with one or more server(s) 220, and the mobile device 212. The server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In some aspects, the server 220 may also store vehicle 202 interior geometry information. For example, the server 220 may store vehicle 202 interior 3D model, vehicle 202 steering wheel (e.g., the steering wheel 120) geometry, pitch, roll and yaw information associated with the camera 118, and/or the like.

In accordance with some aspects, the VCU 206 may share a power bus with the automotive computer 204, and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a steering wheel angle sensor 236, a Radio Detection and Ranging (RADAR or “radar”) sensor, sitting area buckle sensors, sitting area sensors, a Light Detecting and Ranging (LiDAR or “lidar”) sensor, door sensors, proximity sensors, temperature sensors (not shown), etc. A person ordinarily skilled in the art may appreciate that the steering wheel angle sensor 236 may be disposed on a steering wheel shaft/column and may be configured to determine a steering wheel rotation angle when the driver rotates the steering wheel 120.

In some aspects, the VCU 206 may control vehicle 202 operational aspects and implement one or more instruction sets received from the mobile device 212, from one or more instruction sets stored in the memory 218, including instructions operational as part of the driver alertness detection system 208.

The TCU 228 can be configured and/or programmed to provide vehicle connectivity to wireless computing systems onboard and off board the vehicle 202, and may include a Navigation (NAV) receiver 238 for receiving and processing a GPS signal, a BLE® Module (BLEM) 240, a Wi-Fi transceiver, a UWB transceiver, and/or other wireless transceivers (not shown in FIG. 2) that may be configurable for wireless communication between the vehicle 202 and other systems (e.g., a vehicle key fob, not shown in FIG. 2), computers, and modules. The TCU 228 may be disposed in communication with the ECUs 210 by way of a bus.

In one aspect, the ECUs 210 may control aspects of vehicle operation and communication using inputs from human drivers, inputs from an autonomous vehicle controller, the driver alertness detection system 208, and/or via wireless signal inputs received via the wireless connection(s) from other connected devices, such as the mobile device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights, windows, security, cameras (e.g., the camera 118), audio system(s), speakers, door locks and access control, vehicle energy management, and various comfort controls. The BCM 222 may also operate as a gateway for bus and network interfaces to interact with remote ECUs (not shown in FIG. 2).

In some aspects, the DAT controller 230 may provide Level-1 through Level-3 automated driving and driver assistance functionality that can include, for example, active parking assistance, trailer backup assistance, adaptive cruise control, lane keeping, and/or driver status monitoring, among other features. The DAT controller 230 may also provide aspects of user and environmental inputs usable for user authentication.

In some aspects, the automotive computer 204 may connect with an infotainment system 242 that may include a touchscreen interface portion, and may include voice recognition features, biometric identification capabilities that can identify users based on facial recognition, voice recognition, fingerprint identification, or other biological identification means. In other aspects, the infotainment system 242 may be further configured to receive user instructions via the touchscreen interface portion, and/or display notifications, etc. on the touchscreen interface portion.

The computing system architecture of the automotive computer 204, the VCU 206, and/or the driver alertness detection system 208 may omit certain computing modules. It should be readily understood that the computing environment depicted in FIG. 2 is an example of a possible implementation according to the present disclosure, and thus, it should not be considered limiting or exclusive.

In accordance with some aspects, the driver alertness detection system 208 may be integrated with and/or executed as part of the ECUs 210. The driver alertness detection system 208, regardless of whether it is integrated with the automotive computer 204 or the ECUs 210, or whether it operates as an independent computing system in the vehicle 202, may include a transceiver 244, a processor 246, a computer-readable memory 248, a light signal receiver or light receiver 250, and interior vehicle 202 camera assembly including the camera 118 (not shown in FIG. 2) and the light sources 122a, 122b (not shown in FIG. 2). The transceiver 244 may be configured to receive information/inputs from external devices or systems, e.g., the mobile device 212, the server 220, and/or the like. Further, the transceiver 244 may transmit notifications (e.g., alert/alarm signals) to the external devices or systems.

The processor 246 and the memory 248 may be same as or similar to the processor 216 and the memory 218, respectively. Specifically, the processor 246 may utilize the memory 248 to store programs in code and/or to store data for performing aspects in accordance with the disclosure. The memory 248 may be a non-transitory computer-readable memory storing the camera calibration program code. The memory 248 may additionally store vehicle 202 interior geometry information. For example, the memory 248 may store vehicle 202 interior 3D model, the steering wheel 120 geometry, pitch, roll and yaw information associated with the camera 118, and/or the like.

The system 208, specifically the processor 246, may be configured to detect the driver's alertness level by using the driver images captured by the camera 118 and output a notification or an alarm when the processor 246 detects that the driver may not be alert. System 208 operation may be understood as follows.

In operation, the camera 118 may capture driver image(s) when the driver drives the vehicle 202 or when the driver sits at the driver sitting area 116. The processor 246 may obtain the driver image from the camera 118, and perform pixel segmentation (or any other known image processing technique, such as nearest neighbor (NN) algorithm or any other similar computer vision algorithm) to detect driver eyes or head orientation, as described in conjunction with FIG. 1. Responsive to detecting the driver eyes orientation, the processor 246 may fetch the vehicle 202 interior 3D model from the memory 248 or the server 220 (via the transceiver 244 and the network 214), and determine vehicle 202 interior portion zone where the driver may be looking based on the detected driver eyes orientation and the vehicle 202 interior 3D model. For example, the processor 246 may determine that the driver may be looking at the passenger foot well zone 110 if the driver eyes are oriented downwards and towards a driver's right side.

Responsive to determining the zone (e.g., the passenger foot well zone 110) at which the driver may be looking, the processor 246 may fetch corresponding time duration threshold associated with the passenger foot well zone 110 (that may be pre-stored in the memory 248) from the memory 248. As described in conjunction with FIG. 1, the time duration threshold may be associated with a time duration for which the driver may view or look at the passenger foot well zone 110 without the system 208 actuating an alarm or a notification.

Responsive to fetching the time duration threshold associated with the passenger foot well zone 110, the processor 246 may determine the time duration for which the driver may look at the passenger foot well zone 110. In some aspects, the processor 246 may determine the time duration by obtaining the driver images from the camera 118 at a predefined frequency (e.g., every 100 ms). When the time duration exceeds the time duration threshold, the processor 246 may send a command signal to the BCM 222 to output an audio notification via the vehicle speakers. The audio notification may include a prompt or a request for the driver to focus back on the road, specifically to move the eyes to the on-road windshield zone 102. In additional aspects, the processor 246 may send the command signal to the infotainment system 242 to output an audio-visual notification prompting the driver to focus back on the road. The processor 246 may additionally transmit, via the transceiver 244 and the network 214, the audio-visual notification to the mobile device 212, so that the mobile device 212 may output the notification.

In further aspects, as described in conjunction with FIG. 1, the system 208 may be configured to detect if the camera 118 is misaligned by using “obstructions” that may be included in the driver images captured by the camera 118. The obstructions may be, for example, steering wheel 120 views (or views of other vehicle components) that may be present in the captured driver images, when the driver rotates the steering wheel 120. The processor 246 may obtain the driver images, with the steering wheel 120 views obstructing the driver images, from the camera 118 and may use the views to detect if the camera 118 is misaligned. Example driver images, with steering wheel 120 views, are depicted in FIG. 3. Specifically, FIG. 3 depicts example snapshots of views captured by the camera 118, in accordance with the present disclosure.

In an exemplary aspect, the processor 246 may obtain an image 302a from the camera 118 when the driver may not have rotated the steering wheel 120. The processor 246 may perform pixel-segmentation of the image 302a to identify one or more elements/components that may be included in the image 302a. For example, the processor 246 may determine that the image 302amay include a view of a driver face 304, a view of a grip handle 306, and/or the like, by performing image 302a pixel-segmentation. In some aspects, the processor 246 may use the vehicle 202 interior 3D model (stored in the memory 248 or the server 220), along with performing the image 302a pixel-segmentation, to identify the elements/components that may be present in the image 302a. Specifically, the vehicle 202 interior 3D model may include location information of each vehicle 202 interior element/component relative to the camera 118, and the processor 246 may use the location information to identify the different elements/components that may be present in the image 302a.

In addition, the processor 246 may calculate an expected illumination level of each element/component in the image 302a, and use the calculated expected illumination level to identify precisely the different elements/components that may be present in the image 302a. For example, the processor 246 may determine a distance of the grip handle 306 from the camera 118 and the light sources 122a, 122b by using the vehicle 202 interior 3D model, and estimate an expected grip handle 306 illumination level in the image 302a based on the determined distance. A person ordinarily skilled in the art may appreciate that the elements/components that may be closer to the light sources 122a, 122b may illuminate more brightly in the image 302a, as compared to the elements/components that may be farther from the light sources 122a, 122b.

Responsive to determining the expected grip handle 306 illumination level in the image 302a and by using the location information of the grip handle 306 relative to the camera 118 (as identified from the vehicle 202 interior 3D model), the processor 246 may identify precisely the grip handle 306 in the image 302a. In a similar manner, the processor 246 may identify other elements/components in the image 302a.

When the driver starts to rotate the steering wheel 120, a steering wheel 120 view may get included in the driver image, as show in images 302b and 302c. In an exemplary aspect, views 314 and 316 may depict the steering wheel 120 in the images 302b and 302c when the driver rotates the steering wheel 120 by 15 degrees and 35 degrees, respectively.

The processor 246 may obtain the image 302b or 302c from the camera 118 when the driver rotates the steering wheel 120. The processor 246 may then identify the steering wheel 120 (or “steering wheel 120 location”) in the image 302b or 302c by using pixel-segmentation, expected steering wheel 120 illumination level, and location information of the steering wheel 120 relative to the camera 118, as described above. A person ordinarily skilled in the art may appreciate that since the camera 118 and the light sources 122a, 122b are disposed in proximity to the steering wheel 120, the steering wheel 120 may illuminate more brightly in the image 302b or 302c as compared to other elements/components that may be present in the image 302b or 302c.

In addition to or alternative to identifying the steering wheel 120 location by using pixel-segmentation and location information of the steering wheel 120 relative to the camera 118, the processor 246 may identify the steering wheel 120 location in the image 302b or 302c by using light beams or signals reflected from the steering wheel 120. Specifically, the light beams/signals emitted from the light sources 122a, 122b may reflect from the steering wheel 120 when the driver rotates the steering wheel 120. The light receiver 250 may receive the reflected light signals from the steering wheel 120, and may send the reflected light signals to the processor 246. The processor 246 may use the reflected light signals to identify the steering wheel 120 location in the image 302b or 302c. For example, in an exemplary aspect, the light sources 122a, 122b may be configured to emit light signals alternatively. The processor 246 may determine that the steering wheel 120 location is in image 302b, 302c left or right side based on whether the steering wheel 120 reflects the light signal reflected from the light source 122a or 122b. Further, as described above, the steering wheel 120 may illuminate at a different level relative to other vehicle interior elements/components (e.g., in image 302b, 302c background) as the steering wheel 120 may be closest to the light sources 122a, 122b. The processor 246 may identify the steering wheel 120 location in the image 302b or 302c based on relative illumination levels of the steering wheel 120 and other vehicle interior elements/components in image 302b, 302c background.

Responsive to identifying the steering wheel 120 location in the image 302b or 302c, the processor 246 may determine an angle “α” or “α′” that may be formed by the view 314 or 316 with respect to X-axis of the image 302b or 302c, as shown in FIG. 3.

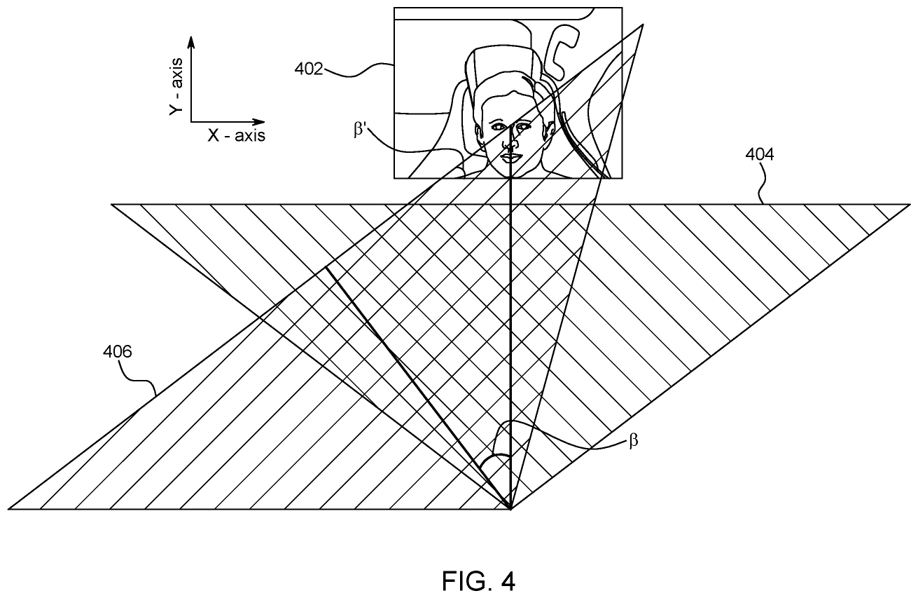

In addition, the processor 246 may obtain the steering wheel rotation angle from the steering wheel angle sensor 236, and determine the angle by which the driver may have rotated the steering wheel 120. For example, the processor 246 may determine that the driver may have rotated the steering wheel 120 by 15 degrees or 35 degrees relative to steering wheel nominal position, based on inputs from the steering wheel angle sensor 236. Responsive to obtaining the steering wheel rotation angle, the processor 246 may determine an “estimated” steering wheel 120 location in the image 302b or 302c based on the steering wheel rotation angle. In some aspects, the estimated steering wheel 120 location may be associated with a steering wheel 120 location in the image 302b or 302c when the camera 118 may be aligned at the camera 118 nominal position (or center-aligned position). Stated another way, the estimated steering wheel 120 location may be same as a steering wheel 120 location in the image 302b or 302c when the camera 118 may not have an alignment or roll error or when the camera 118 may not be misaligned. The concept of determining the estimated steering wheel 120 location may be understood in conjunction with FIG. 4.

FIG. 4 depicts an example snapshot of a driver image 402 obstructed by the steering wheel 120, in accordance with the present disclosure. An exemplary geometric mockup of a triangular steering wheel 120 assembly is depicted in views 404 and 406. Specifically, the view 404 may be associated with a steering wheel 120 orientation when the steering wheel 120 is not rotated (i.e., when the steering wheel rotation angle is zero degrees). In a similar manner, the view 406 may be associated with a steering wheel 120 orientation that the camera 118 may “view” when the steering wheel 120 is rotated by an angle “β” (which may be, for example 15 or 35 degrees) relative to steering wheel 120 center-aligned or nominal position. In some aspects, the camera 118 may “view” the steering wheel 120 orientation by capturing views of steering wheel 120 edges. In other aspects, the steering wheel 120 may include markers, e.g., fiducial markers (that may or may not be visible to the driver), and the camera 118 may capture views of the fiducial markers to capture the steering wheel 120 orientation.

When the camera 118 is aligned at the camera 118 nominal position (with no roll-error or misalignment), the angle “β” by which the driver rotates the steering wheel 120 may be same as or be a function of an angle “β′” that the view 406 may form along an image 402 X-axis. A person ordinarily skilled in the art may appreciate that the functional relationship between the angles “β” and “β′” may depend on the steering wheel 120 geometry, and pitch, roll and yaw information associated with the camera 118 (that may be stored in the memory 248).

Responsive to determining the angle “β” from the steering wheel angle sensor 236, the processor 246 may fetch the steering wheel 120 geometry, and pitch, roll and yaw information associated with the camera 118 from the memory, and determine the functional relationship between the angles “β” and “β′”. Responsive to determining the functional relationship, the processor 246 may calculate the angle “β′”, and hence the estimated steering wheel 120 location in the image 402. In an exemplary aspect (as shown in FIG. 4) where the functional relationship indicates a one-on-one relationship between the angles “β” and “β′”, the processor 246 may determine that the steering wheel 120 may form an angle of 15 or 35 degrees along the image 402 X-axis (i.e., the angle “β′”) when the driver rotates the steering wheel 120 by 15 or 35 degrees (i.e., the angle “β”).

Example estimated steering wheel 120 locations corresponding to steering wheel locations in images 302b and 302c are depicted in FIG. 3 in images 312a and 312b as views 308 and 310. As shown in the views 308 and 310, the estimated steering wheel 120 locations may form angles “γ” and “γ′” along the X-axis of the images 312a and 312b, respectively.

Responsive to determining the estimated steering wheel 120 location in an image (e.g., the view 308 in the image 312a) and “actual” steering wheel 120 location (e.g., the view 314 in the image 302b), the processor 246 may determine an angular difference between the estimated and the actual steering wheel 120 locations. The angular difference may be, for example, a difference between the angles “γ” and “α”. For example, the processor 246 may determine the angular difference to be 2 degrees if “α” (corresponding to the actual steering wheel 120 location in the image 302b) is 37 degrees and “γ” (corresponding to the estimated steering wheel 120 location in the image 312a) is 35 degrees. In some aspects, the angular difference may be associated with a camera 118 roll or alignment error.

Responsive to determining the angular difference, the processor 246 may determine that the angular difference is greater than a predefined threshold (e.g., 0.5, 1 or 2 degrees). The processor 246 may determine the camera 118 to be misaligned if the angular difference is greater than the predefined threshold. For example, if the predefined threshold is 0.5 degrees and the determined angular difference is 2 degrees, the processor 246 may determine that the camera 118 may be misaligned. In some aspects, the predefined threshold may be close to zero. In this case, even if the angular difference is substantially small (e.g., 0.1 degrees), the processor 246 may determine that the camera 118 may be misaligned.

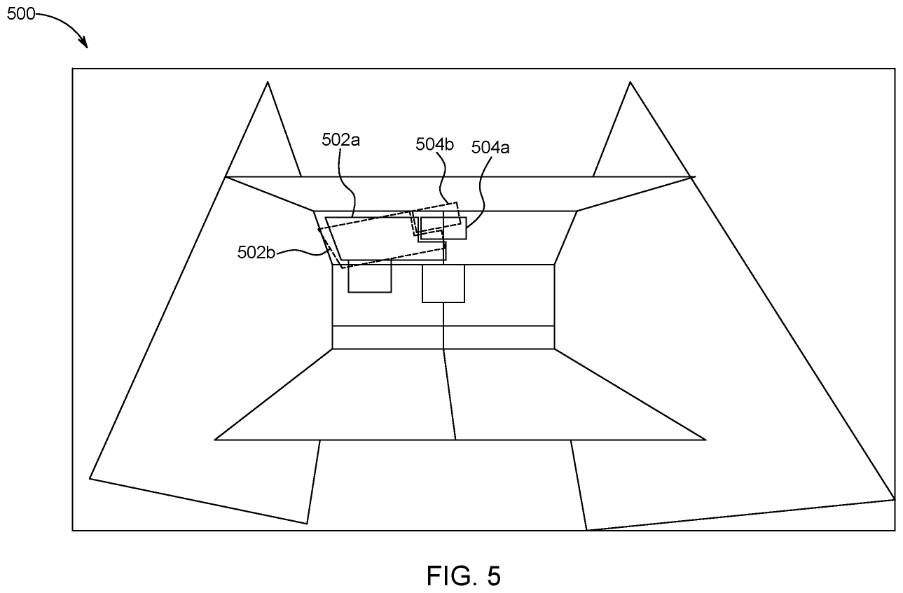

Responsive to determining that the camera 118 may be misaligned, the processor 246 may update a camera 118 calibration model. Specifically, the processor 246 may update the camera 118 calibration model by updating the vehicle 202 interior 3D model stored in the memory 248 or the server 220. Updating of the vehicle 202 interior 3D model may be understood in conjunction with FIG. 5.

In some aspects, the processor 246 may also update vehicle's decentralized identifiers (vehicle DIDs) or vehicle diagnostic trouble code (DTC), responsive to determining that the camera 118 may be misaligned.

FIG. 5 depicts an example 3D vehicle 202 model 500 in accordance with the present disclosure. The model 500 may be a 3D model of the one or more zones depicted in FIG. 1. For example, zones 502a, 502b may be same as the on-road windshield zone 102, zones 504a, 504b may be same as the rear-view mirror zone 114, and/or the like. In some aspects, the zones 502a and 504a may be associated with views of the on-road windshield zone 102 and the rear-view mirror zone 114 that the camera 118 may “view” when the camera 118 is not misaligned. On the other hand, the zones 502b and 504b may be associated with views of the on-road windshield zone 102 and the rear-view mirror zone 114 that the camera 118 may view when the camera 118 may be misaligned.

Responsive to determining that the camera 118 may be misaligned, the processor 246 may update (e.g., tilt, rotate, laterally or vertically move, etc.) the model 500 so that the camera 118 may correctly view the one or more zones in the vehicle 202 interior portion. For example, if the processor 246 determines that the angular difference is 2 degrees, the processor 246 may update the model 500 by tilting the model 500 by 2 degrees. Responsive to updating the model 500, the processor 246 may store the updated model 500 in the memory 248 and/or the server 220.

In some aspects, the processor 246 may rotate the image captured by the camera 118 (e.g., instead of or in addition to updating the model 500) to correctly determine driver gaze in the captured image.

A person ordinarily skilled in the art may appreciate that by updating the model 500, the processor 246 may correctly determine the zone at which the driver may be looking, even if the camera 118 is misaligned. Therefore, probability of incorrect detection of driver eyes or head orientation (and hence probability of false alarms) is significantly reduced by using the driver alertness detection system 208, as described in the present disclosure. Further, the present disclosure eliminates the need for end of line calibration to correct camera 118 misalignment.

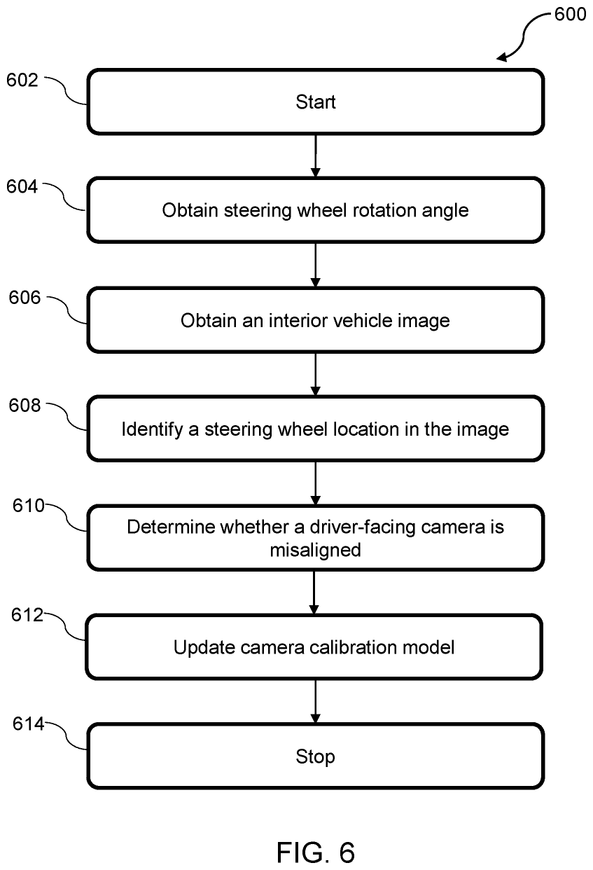

FIG. 6 depicts a flow diagram of an example method 600 for vehicle camera calibration, in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

Referring to FIG. 6, at step 602, the method 600 may commence. At step 604, the method 600 may include obtaining, by the processor 246, the steering wheel 120 rotation angle from the steering wheel angle sensor 236. At step 606, the method 600 may include obtaining, by the processor 246, an interior vehicle image (e.g., the image 302b) from the camera 118.

At step 608, the method 600 may include identifying, by the processor 246, the steering wheel 120 location in the image 302b. Specifically, as described in conjunction with FIGS. 2 and 3, the processor 246 may determine the angle “α” formed by the view 314 of the steering wheel 120 in the image 302b.

At step 610, the method 600 may include determining, by the processor 246, whether the camera 118 is misaligned based on the identified steering wheel 120 location in the image 302b and the steering wheel 120 rotation angle. The process of determining that the camera 118 is misaligned is already explained in conjunction with FIG. 2.

At step 612, the method 600 may include updating, by the processor 246, the camera 118 calibration model when the processor 246 determines that the camera 118 may be misaligned.

As described in conjunction with FIG. 2, the processor 246 updates the camera 118 calibration model by updating the vehicle 202 interior 3D model that may be stored in the memory 248.

At step 614, the method 600 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,”“an embodiment,”“an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,”“the,”“said,” etc. should be read to recite one or more of the indicated elements unless a claim recites an explicit limitation to the contrary. Conditional language, such as, among others, “can,”“could,”“might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a steering wheel assembly comprising a steering wheel and a steering wheel angle sensor;
an interior vehicle camera assembly mounted in proximity to the steering wheel; and
a processor configured to:
obtain a steering wheel rotation angle from the steering wheel angle sensor;
obtain an interior vehicle image from the interior vehicle camera assembly;
identify a steering wheel location in the interior vehicle image;
determine that the interior vehicle camera assembly is misaligned based on the steering wheel location and the steering wheel rotation angle; and
update a camera calibration model responsive to determining that the interior vehicle camera assembly is misaligned.

2. The vehicle of claim 1 further comprising a memory configured to store a vehicle interior portion 3-dimensional (3D) model.

3. The vehicle of claim 2, wherein the processor updates the camera calibration model by updating the vehicle interior portion 3D model.

4. The vehicle of claim 1, wherein the processor is further configured to:
perform pixel segmentation of the interior vehicle image; and
identify the steering wheel location in the interior vehicle image based on the pixel segmentation.

5. The vehicle of claim 4, wherein the processor is further configured to:
determine an estimated steering wheel location in the interior vehicle image based on the steering wheel rotation angle;
determine an angular difference between the estimated steering wheel location and the steering wheel location; and
determine that the angular difference is greater than a threshold,
wherein the processor determines that the interior vehicle camera assembly is misaligned when the angular difference is greater than the threshold.

6. The vehicle of claim 5, wherein the interior vehicle camera assembly comprises a driver-facing camera, a first light source and a second light source.

7. The vehicle of claim 6, wherein the first light source and the second light source are Near-infrared (NIR) light sources.

8. The vehicle of claim 6, wherein the first light source is disposed in proximity to a driver-facing camera left side, and wherein the second light source is disposed in proximity to a driver-facing camera right side.

9. The vehicle of claim 6, wherein the interior vehicle camera assembly further comprises a receiver configured to receive a light signal reflected from the steering wheel, and wherein the light signal is emitted from the first light source or the second light source.

10. The vehicle of claim 9, wherein the processor is further configured to:
obtain the light signal reflected from the steering wheel from the receiver; and
identify the steering wheel location in the interior vehicle image based on the light signal reflected from the steering wheel.

11. A method for camera calibration in a vehicle, the method comprising:
obtaining, by a processor, a steering wheel rotation angle from a steering wheel angle sensor, wherein the vehicle comprises a steering wheel assembly comprising a steering wheel and the steering wheel angle sensor;
obtaining, by the processor, an interior vehicle image from an interior vehicle camera assembly, wherein the interior vehicle camera assembly is mounted in proximity to the steering wheel;
identifying, by the processor, a steering wheel location in the interior vehicle image;
determining, by the processor, that the interior vehicle camera assembly is misaligned based on the steering wheel location and the steering wheel rotation angle; and
updating, by the processor, a camera calibration model responsive to determining that the interior vehicle camera assembly is misaligned.

12. The method of claim 11 further comprising:
performing pixel segmentation of the interior vehicle image; and
identifying the steering wheel location in the interior vehicle image based on the pixel segmentation.

13. The method of claim 12 further comprising:
determining an estimated steering wheel location in the interior vehicle image based on the steering wheel rotation angle;
determining an angular difference between the estimated steering wheel location and the steering wheel location; and
determining that the angular difference is greater than a threshold, wherein the interior vehicle camera assembly is misaligned when the angular difference is greater than the threshold.

14. The method of claim 13, wherein the interior vehicle camera assembly comprises a driver-facing camera, a first light source and a second light source.

15. The method of claim 14, wherein the first light source and the second light source are Near-infrared (NIR) light sources.

16. The method of claim 14, wherein the first light source is disposed in proximity to a driver-facing camera left side, and wherein the second light source is disposed in proximity to a driver-facing camera right side.

17. The method of claim 14 further comprising obtaining a light signal reflected from the steering wheel, wherein the light signal is emitted from the first light source or the second light source.

18. The method of claim 17 further comprising identifying the steering wheel location in the interior vehicle image based on the light signal reflected from the steering wheel.

19. A non-transitory computer-readable storage medium having instructions stored thereupon which, when executed by a processor, cause the processor to:
obtain a steering wheel rotation angle from a steering wheel angle sensor of a vehicle, wherein the vehicle comprises a steering wheel assembly comprising a steering wheel and the steering wheel angle sensor;
obtain an interior vehicle image from an interior vehicle camera assembly, wherein the interior vehicle camera assembly is mounted in proximity to the steering wheel;
identify a steering wheel location in the interior vehicle image;
determine that the interior vehicle camera assembly is misaligned based on the steering wheel location and the steering wheel rotation angle; and
update a camera calibration model responsive to determining that the interior vehicle camera assembly is misaligned.

20. The non-transitory computer-readable storage medium of claim 19, wherein the interior vehicle camera assembly comprises a driver-facing camera, a first light source and a second light source.
